(19) United States
(12) Patent Application Publication
(10) Pub. No.: US 2006/0059325 A1
(43) Pub. Date: Mar. 16, 2006

(54) Apparatus and method for assigning addresses to components or modules in a system

(76) Inventors: Alan Leslie Milne, Edinburgh (GB); Paul Maguire, Edinburgh (GB); Grant Sharp, Kirkcaldy (GB); Ian Moody, Edinburgh (GB); Erik Lornie, West Calder (GB)

Correspondence Address: PERMAN & GREEN, 425 POST ROAD, FAIRFIELD, CT, 06824, US

(21) Appl. No.: 10/939,141

(22) Filed: Sep. 10, 2004

(51) Int. Cl. G06F 9/34

(52) U.S. Cl. 711/200

(57) ABSTRACT

A system having replaceable components, each with a MAC address provided by its manufacturer, includes a central system controller which generates predetermined MAC addresses each associated with a slot into which the components are inserted. When a component (card) is inserted into a slot, the controller checks the MAC address of the card and compares it with the MAC address of the slot. If it is not the same (as when a new card is inserted, rather than the same card being re-inserted), the controller instructs the card to store the predetermined MAC address associated with that slot and to use that address as its MAC address. The original MAC address provided by the manufacturer is not deleted but is maintained in a memory location so that it can be accessed when necessary.

This invention relates to an apparatus and method for assigning addresses to components or modules In a system, particularly, though not exclusively, to an apparatus and method for assigning network addresses to components or modules in a network system to enable different components or modules within the system to communicate with each other.

### BACKGROUND OF THE INVENTION

In modern communications systems (in particular, the modern Internet) it has become common to construct networks and network equipment in a modular design. There may be several separate devices which are coupled together, or one central system component to which several other components are coupled. This modular design allows an individual device to be removed from the system, for example, for diagnostic testing of faults or for a visual inspection; this may lead to the device being replaced in the system or for another device to be substituted in its place. In order for these modules or devices to communicate with each other, it is necessary for them to possess information about the system configuration, for example, to have a method of identifying each other. Thus, it is common for each device to have a unique identifier or address, such a Media Access Control (MAC) address. MAC addresses are assigned to a module or device by the manufacturer of that module or device and remain with the module or device. Thus, if a new module or device is inserted into a system, the system must “learn” the MAC address of the new module or device. Similarly, if a previously used module or device is inserted into a new location In the system, the system must update the system configuration details. The system configuration details are generally maintained in a table stored in a memory or database, in which the MAC addresses of the various modules or devices are stored. As will be appreciated, if a device or module is removed from a slot, then the table needs to be updated with the new MAC address of the module or device that is inserted into that slot, even if it is the same module or device that was previously there.

U.S. patent application No. 2003/0018804 (Laxman) discloses a method and apparatus for assigning a MAC address to a physical location or slot in the system. When a card (that is, module or device) is inserted into a slot in the system, the insertion of the card is detected and the original MAC address of the card is overwritten with that of the slot. Thus, the table of MAC addresses stored by the system and any other components need not be changed every time a card is removed. However, by rewriting the MAC address on the card, the card itself has “lost” the identity that it had by virtue of the original MAC address assigned by the manufacturer. If the rewriting process is not entirely successful, then the card may be left with no MAC address at all.

### BRIEF SUMMARY OF THE INVENTION

In one aspect, the present invention provides an apparatus for assigning addresses to components in a system, the apparatus comprising a central system controller including at least a memory, and a system communications bus coupled to the central system controller and having a plurality of locations for receiving replaceable components into electrical communication therewith, each of the plurality of locations having a predetermined address associated therewith, information relating to the predetermined addresses being stored in the memory of the central system controller; wherein the central system controller further comprises a processing module for interrogating, via the system communications bus, a component when it is initially electrically connected to one of the locations of the system communications bus for determining whether there is a component address stored in a memory location of the component that matches the predetermined address associated with that location, and, if not, for issuing instructions to the component to store the predetermined address in a memory location therein and to use the stored predetermined address as its component address, at least while the component is electrically connected to that location of the system communications bus.

The component may comprise a first memory location in which is stored an original component address that may be provided by a manufacturer of the component, the predetermined address being written into a second memory location such that the original component address is maintained in the first memory location.

In one embodiment, the central system controller may store in its memory an indication of whether there is a component address stored in a memory location of the component that matches the predetermined address.

When a component is initially electrically connected to one of the locations of the system communications bus, the central system controller may receive a message from the component requesting verification that its component address is correct and the central system controller checks its memory to determine whether there is an indication that there is a component address stored in a memory location of the component that matches the predetermined address and, if so, sends a confirmation message to the component.

According to a second aspect, the invention provides a system for assigning addresses to components in the system, the system comprising a central system controller including at least a memory, and a system communications bus coupled to the central system controller and having a plurality of locations for receiving replaceable components into electrical communication therewith, each of the plurality of locations having a predetermined address associated therewith, information relating to the predetermined addresses being stored in the memory of the central system controller, and at least one component electrically coupled respectively at one of the plurality of locations to the system communications bus, the component including at least a first memory location having an original component address stored therein and a second memory location for storing a current component address, wherein the central system controller further comprises a processing module for interrogating, via the system communications bus, the component when it is initially electrically connected to the system communications bus for determining whether there is a component address stored in a the second memory location of the component that matches the predetermined address associated with that location, and, if not, for issuing instructions to the component to store the predetermined address in the second memory location therein and to use the stored predetermined address as its current component address, at least while the component is electrically connected to that location of the system communications bus.

In one embodiment, the central system controller may store in its memory an indication of whether there is a component address stored in the second memory location of the component that matches the predetermined address.

When the component is initially electrically connected to one of the locations of the system communications bus, the component may send a message to the central system controller requesting verification that its component address is correct and the central system controller checks its memory to determine whether there is an indication that there is a component address stored in the second memory location of the component that matches the predetermined address and, if so, sends a confirmation message to the component.

According to a third aspect, the invention provides a method of assigning addresses to components in a system, the method comprising the steps of detecting a component newly inserted at a location in the system, reading a component address stored in the component, comparing the component address with a predetermined address associated with the location at which the component has been inserted, and if the component address and the predetermined address do not match, then instructing the component to store the predetermined address and to use it as its component address, at least while it is electrically connected to that location of the system.

The method may further comprise a step of storing in the memory of the central system controller an indication of whether there is a component address stored in the component that matches the predetermined address.

The method may further comprise a step of sending a message from the component to the central system controller after the component is initially electrically connected to one of the locations of the system communications bus requesting verification that its component address is correct; and the central system controller checking its memory for the indication whether there is a component address stored in the component that matches the predetermined address and, if so, sending a confirmation message to the component.

The method may further comprise a step of storing an original component address in a first memory location of the component, and writing the predetermined address into a second memory location such that the original component address is maintained in the first memory location.

The component may use its original component address as its component address if there is no valid component address stored in its second memory location.

In an embodiment of the invention, the processing module of the central system controller may use Intelligent Platform Management Interface (IPMI) protocol to communicate with the component.

The predetermined address may be calculated from a set of rules, which may include an algorithm for generating the predetermined address from a component address of a component in the system that is not replaceable.

The component address may be a Media Access Control (MAC) address.

### BRIEF DESCRIPTION OF THE DRAWINGS

One embodiment of the invention will now be more fully described, by way of example, with reference to the drawings, of which:

FIG. 1 shows a block diagram of a system incorporating the apparatus according to one embodiment of the present invention;

FIG. 2 shows a schematic flow chart of the operation of a central controller initiated process for applying a predetermined MAC address to an inserted component in the apparatus shown in FIG. 1; and

FIG. 3 shows a schematic flow chart of the operation of a newly inserted component initiated process for verifying a MAC address in the apparatus shown in FIG. 1.

### DETAILED DESCRIPTION OF THE DRAWINGS

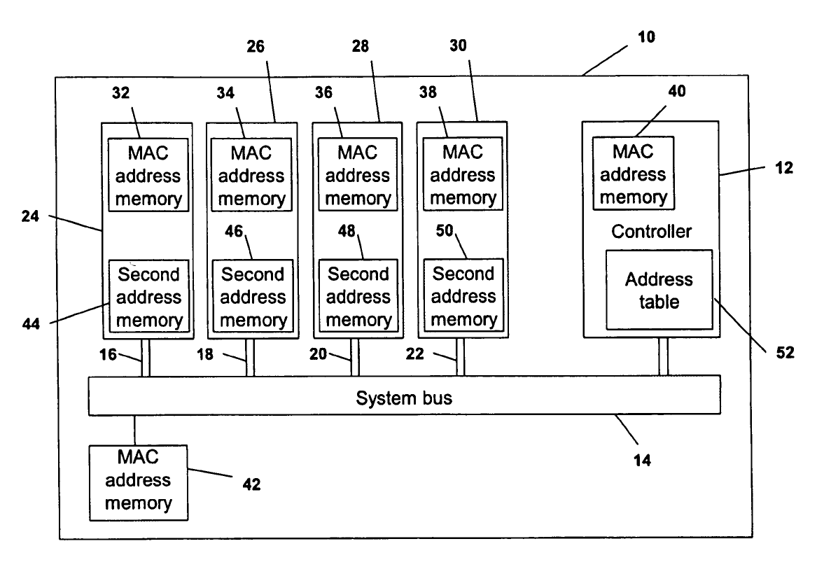

Thus, FIG. 1 is a schematic diagram illustrating the architecture of a system 10 incorporating one embodiment of the present invention. The system 10 has a central system controller 12 connected via a system bus 14 to several slots 16, 18, 20 and 22 in which components 24, 26, 28 and 30, are inserted. The components 24, 26, 28 and 30 may be removable from the slots 16-22. The slots 16-22 each include a physical connector mechanism and electrical connector mechanism whereby part of the component, which is often a card, can be inserted into the slot and thereby be mechanically retained therein in such a manner that electrical connection is made between the component and the slot, which is itself electrically connected to the bus 14. The bus 14 may be, for example, an I²C bus that supports communications using Intelligent Platform Management Interface (IPMI) protocol between the central controller 12 and the various components connected to the bus.

As mentioned above, the central system controller 12 and the components 24-30 are each provided with a unique MAC address by their respective manufacturer. The MAC addresses are stored in a first memory location 32, 34, 36 and 38 of the component 24, 26, 28 and 30, and in a first memory location 40 of the central controller 12. In the embodiment shown, the bus 14 forms part of the chassis of the system 10 and has its own MAC address stored in a memory location 42.

The MAC address is so called because it operates in the MAC sub-layer, of the Data link layer, of the well known Open Systems Interconnect (OSI) model. The data link layer has protocols operating within it which are responsible for tasks such as creating, transmitting and receiving packets of data, physical addressing, logical link control processing creating logical topologies and controlling media access. Data, from protocols in upper layers of the OSI model, is divided into logical chunks, or units of data transmission, called packets, in the data link layer. The size and format of the packets is dependent upon the transmission technology used to deliver the packets.

MAC addresses are typically 12 digit hexadecimal numbers, each two-digit set being separated by colons, for example 07:58:AB:2F:B3:92. The MAC address is a hardware address; it is protocol independent. Normally MAC addresses are set in the factory by hardware manufacturers and cannot be changed. Manufacturers using MAC address are assigned a block of MAC addresses by the Institute of Electrical and Electronics Engineers, IEEE. Traditionally the manufacturers keep a record of the addresses within their block used, so that a MAC address is not used twice. However some manufacturers are starting to reuse their blocks of MAC addresses; this means it may necessary to change the MAC address. For example, if a conflict exists due to two pieces of hardware having the same MAC address, the MAC address of one of the pieces of hardware may need to be changed using a software program supplied by the manufacturer.

In general, these “original” manufacturer-assigned MAC addresses of all the components in the system will be stored in some form of memory, such as electrically erasable programmable read-only memory (EEPROM), or perhaps flash memory, but could alternatively be stored in non-programmable memory, such as Read Only Memory (ROM), or any other suitable data storage medium.

The central system controller 12 may include a table 52 which stores the MAC addresses of the components 24-30. This table 52 additionally holds a list of logical addresses for each of the components 24-30. The logical addresses are defined by a protocol addressing scheme, such as IP or IPX in the Network layer of the OSI model. Logical addresses are protocol dependent; an IP address is distinct from an IPX address. Protocols which ensure that data arrives at the correct destination exist and operate in the Network layer. It is therefore necessary to be able to associate a physical (MAC) address with a logical (IP) address.

It may, at times, be desirable or necessary to remove any of the components 24-30 from their slots 16-22 in the system 10, whether to replace with a different component or just to carry out a visual inspection. If a component 24-30 is replaced by an alternative component, then the advertised MAC address of the new component may not be the same as that of the original component. In known networks, this would require a manual update of a network table that maps MAC addresses to IP addresses.

In the present embodiment, to automate this configuration and obviate the need for manual intervention, each replaceable component 24-30 is also provided with a second memory location 44-50, in which is stored a MAC address of the component which can be “advertised” to the rest of the system. These secondary MAC addresses are also stored in some form of memory, such as electrically erasable programmable read-only memory (EEPROM), or perhaps flash memory, or any other suitable data storage medium, provided that the memory can be reprogrammed. It will be apparent, that, if the first memory locations and the second memory locations are provided in the same type of memory, they can be provided in the same physical memory on each component, if desired.

However, in this embodiment of the present invention, the secondary MAC address of each of the replaceable components 24-30 in the system is determined by the central controller 12 according to the slots 16-22 into which the components have been inserted. More particularly, each slot is provided with a predetermined MAC address and these predetermined MAC addresses are also stored in the table 52 on the central system controller 12 together with the slots to which they relate. The table 52 may simply store a list of MAC addresses or may store a set of rules from which to calculate the MAC addresses.

Thus, when a component 24-30 is inserted into a slot (whether for the first time or being replaced into the same slot that it was taken out of), a process whereby the advertised MAC address of the component Is checked by the central controller 12, is set into operation. When the central system controller 12 detects that a component 24-30 has been inserted into a slot 16-22, it queries the component 24-30 to find out its MAC address. This MAC address will be the secondary MAC address from the second memory location. The central controller 12 then checks this MAC address against the predetermined MAC address stored in table 52 for the particular slot that the component has been inserted into. If the addresses match then the central controller will store this fact in its memory. In the present embodiment, using the IPMI protocol, the secondary MAC address may be determined by reading the component's Field Replaceable Unit ID (FRUID), by sending a “Read FRUID” command.

If the secondary MAC address of the component does not match the predetermined MAC address for the corresponding slot according to the table 52 in the central controller 12, then the central system controller 12 sends an instruction to write the correct predetermined MAC address to the component's second memory location. The component will, of course, retain its original MAC address in the first memory location. Thus, this process does not change the original MAC address written by the component manufacturer in the first memory location. The original MAC address still exists in the storage medium of the card but the “correct” secondary MAC address for the slot into which it has been inserted is stored in the second memory location in the component. Thus, the MAC address visible to the system 10 is effectively changed, while the original MAC address is hidden or masked behind the advertised MAC address. After writing the new MAC address to the second memory location, the component sends a “write confirmation” message to the central controller 12 and the central controller 12 stores and indication that the write command has been successfully carried out in its memory.

In the embodiment shown, a set of rules can be used to determine the MAC address of each slot. In this embodiment, as described above, the chassis has a unique MAC address associated with it that is stored in the memory 42, which may be an EEPROM. The MAC addresses of each of the slots 16-30 (and possibly the central system controller 12) are calculated from the chassis MAC address. The central system controller 12 will determine the chassis MAC address by interrogating the EEPROM 42. This may be achieved by reading the EEPROM's Field Replaceable Unit ID (FRUID), by sending a “Read FRUID” command.

Table 1 shows one possible way of calculating MAC addresses from the chassis address, in which the MAC address is given by;
MACaddress=ChassisMACaddress+2n(n=0,1,2,3 . . .)

where n is an integer number beginning at 0 (starting at 0 ensures that the chassis MAC address is used, since otherwise this MAC address would not be used as the chassis is not otherwise communicated with in this embodiment):

TABLE 1
MAC address calculation.
(Reference numerals from FIG. 1 are shown in parentheses.)

| Slot number | MAC address |
|---|---|
| 1 (16) | Chassis MAC address |
| 2 (18) | Chassis MAC address +2 |
| 3 (20) | Chassis MAC address +4 |
| 4 (22) | Chassis MAC address +6 |

It will be apparent that the MAC address of the central controller 12 can be changed to fit this pattern, if desired, in which case the central controller 12 will also require a second memory location to store its new predetermined MAC address. However, since the central controller will not usually be removed or replaced, this is not essential. Furthermore, the central controller's original MAC address could be used as the starting point for determining all the other MAC addresses, although, again, since the chassis (or bus 14) are unlikely to be removed or replaced, it is not essential that the MAC address stored in memory 42 be changed.

When a component is inserted into a slot, the component will send a MAC address verification request to the central controller to confirm that the MAC address it is using is the correct one. This verification request message originated from the component and is independent of the central controller's initial message requesting the component's MAC address. Since these two requests are independent, there is no way of determining which one will be generated first, and, consequently, whether the process initialized by one of these messages will be completed before the process initialized by the other of these two messages starts. Thus, the two processes will run independently of each other, but the results are dependent on each other, as will be explained below.

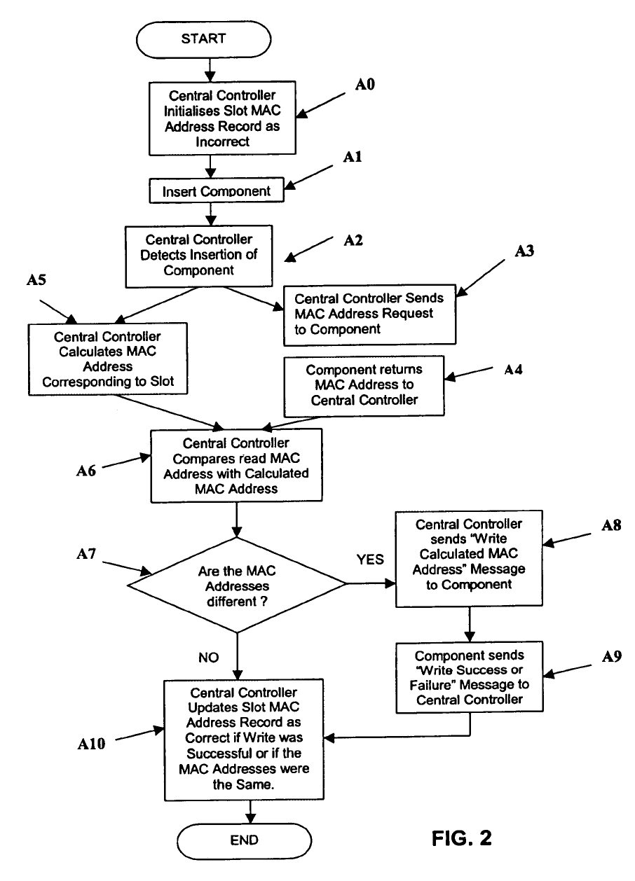

The process of checking the advertised MAC address of a newly inserted component and writing a new MAC address thereto if necessary will now be described in more detail with reference to FIG. 2:
Step A0 When the central system controller (12) is powered up, it first initializes all slot MAC address records in its memory as being incorrect. The slot MAC address records provide an indication of whether the MAC address of a component in a respective slot has been read and found to be correct, or has been found to be incorrect and has then been correctly written. Thus, the default state for each slot record is “incorrect”.
Step A1 At some time, a component 24-30 is inserted into one of the slots 16-22 of the system 10.
Step A2 This step follows from step A1. The central system controller (CSC) 12 detects that a component 24-30 has been newly inserted.
Step A3 This step follows from step A2. The central system controller 12 sends a message to the inserted component to read the MAC address from the second memory location. The second memory location may have no MAC address if the card is a new card, or may have a previously written MAC address, which may be correct (if the card is being re-inserted) or may be incorrect if the card is being inserted into this slot after having been used in another slot.
Step A4 This step follows from step A3. The inserted component returns a message comprising the FRUID data to the central system controller 12.
Step A5 This step also follows from step A2. The central system controller 12 calculates the predetermined MAC address for the slot 16-22 into which the component has been inserted. Alternatively, if the predetermined MAC addresses have already been calculated and are merely stored in a memory, then the memory Is accessed to read the predetermined MAC address.
Step A6 This step follows from steps A5 and A4. The predetermined MAC address from step A5 and the MAC address returned in step A4 are compared by the central system controller 12.
Step A7 The central system controller 12 determines whether the predetermined MAC address from step A5 and the MAC address returned in step A4 are different. This step is followed by step A10 if the two MAC addresses are the same. If the two MAC addresses are different then this step is followed by step A8.
Step A8 This step follows step A7 if the two MAC addresses are different. In this case, the central system controller 12 sends a message to the newly inserted component instructing it to write the predetermined MAC address calculated (or read) in step A5 to its second memory location.
Step A9 This step follows step A8. The component, having successfully written the predetermined MAC address into its second memory location, sends a confirmation message to the central system controller confirming that the predetermined MAC address has been successfully written,
Step A10 This step follows from step A7 if the two MAC addresses compared in step A7 are the same and from step A9 if the two MAC addresses are different and the predetermined MAC address has been written successfully into the second memory location of the component. In either case, the central memory controller changes the slot MAC address record for that particular slot to indicate that the MAC address if that component now matches the predetermined MAC address for that slot and is therefore correct.

This completes the process initialized by the central system controller. Whilst step A5 has been described above as operating substantially simultaneously with steps A3 and A4, it will be appreciated that step A5 could be carried out before step A3, between steps A3 and A4 or after step A4.

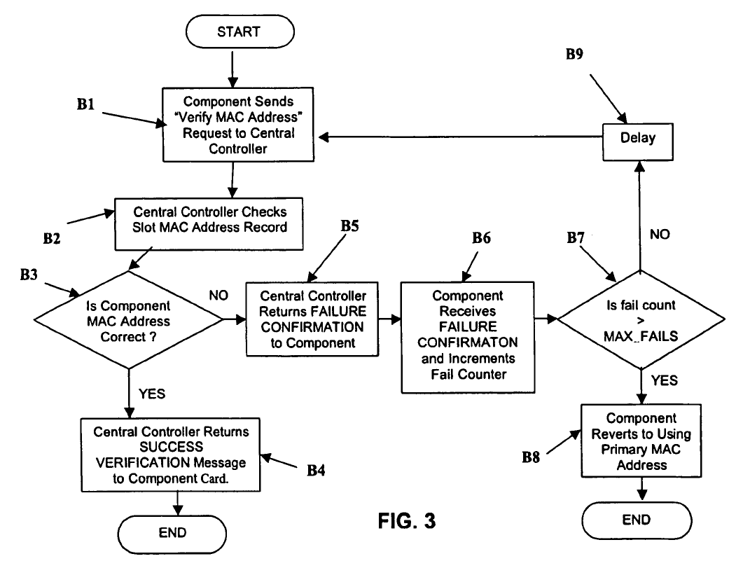

As mentioned above, independently of this process, the component, when it has been inserted into a slot, will need to initialize its circuitry and confirm that its MAC address is correct. This process will now be described in more detail with reference to FIG. 3:
Step B1 The newly inserted component sends a verification request message to the central system controller 12 to verify that it has the correct MAC address.
Step B2 This step follows step B1. The central system controller 12 checks the slot MAC address record for that particular slot in its memory.
Step B3 This step follows step B2. If the slot MAC address record indicates that the Component MAC address is correct then step B4 follows. If the slot MAC address record indicates that the component MAC address is incorrect, then step B5 follows.
Step B4 This step follows step B3 if the slot MAC address record indicates that the Component MAC address is correct. The central system controller 12 then sends a Verification Success confirmation message to the inserted component indicating that the MAC address it is using is correct. This completes this process. The component then knows that it has the correct MAC address and can then initialize any onboard devices required for its operation, which may include LAN or Ethernet devices.
Step B5 This step follows step B3 if the slot MAC address record indicates that the Component MAC address is incorrect. In this situation, the central system controller 12 sends a Failure message indicating to the inserted component that the MAC address it is using is incorrect
Step B6 This step follows step B5. When the component receives a Failure message indicating that its MAC address is incorrect, it increments a failure counter which keeps a record of the number of times that the component has requested a MAC address verification and received a Failure of Verification message.
Step B7 This step follows step B6. Every time the failure counter is incremented, the component checks whether the fail count is greater than a predetermined limit. If the count is greater than the predetermined limit, the process moves on to step B8. If the count is not greater than the predetermined limit, the process moves on to step B9.
Step B8 This step follows from step B7 if the count is greater than the predetermined limit. In this case, since the component cannot get a verification from the controller that the MAC address in its second memory location is correct, it reverts to using the original MAC address in its first memory location, so that it can continue to operate with a MAC address. It will be appreciated that an alarm could also be raised to indicate that a new MAC address could not be written to the newly inserted component. The process then ends.
Step B9 This step follows from step B7 if the count is not greater than the predetermined limit. In this case, a delay is inserted into the process to enable the process of FIG. 2 to complete, if, for example, it started later that the process of FIG. 3, or otherwise had not yet completed. After the delay, the process reverts back to step B1, with the component sending another verification request message to the central system controller 12 to verify that it has the correct MAC address

It is envisaged that the above described processes will be carried out using the Intelligent Platform Management Interface (IPMI) protocol. This will enable communications to take place over an Intelligent Platform Management Bus (IPMB), so that information can be exchanged during the initial stages of system start up, when other protocols may be unavailable, although It will be appreciated that other simple communication protocols could be used. Additionally, the IPMI Platform Event message can been used, with customization, to provide the component verification message of step B1.

The system 10 can use the IPMI message “Read FRUID” to determine the MAC address of an inserted component or of the chassis. A write command “Write FRU Inventory Data” can be used to write the correct MAC address to the inserted component. This message will include the correct predetermined MAC address, which was calculated by the central system controller 12, as a specific customised field.

Thus, it will be appreciated that the processes do not change the original MAC address written into the first memory location of the newly inserted component. Instead, the “advertised” MAC address in the second memory location is changed, thereby allowing the original MAC address to remain in memory on the component to be accessed if necessary.

It will be appreciated that although only one embodiment of the invention has been described in detail, various modifications and improvements can be made by a person skilled in the art without departing from the scope of the invention.

For example, events other than insertion or “hot swap” of a component into the system 10 may occur which trigger the process to begin. These may include hardware or software resets, a faulty or missing component or may be part of a maintenance routine. It is envisaged that the present invention may be utilised in network equipment using or monitoring the signaling protocol known as Signaling System No.7 (SS7), although the invention could find use in other systems. Furthermore, although the present invention has been described as operating locally within a single unit of equipment, it could be worked over a network, between units of equipment, for example to prevent MAC Address conflicts on Network Interface Cards (NIC's).

Thus, in at least this embodiment, the original MAC address of the card is masked or hidden by the MAC address of the physical location or slot that the card in inserted into. Furthermore, means for interrogating the system component using a simple communications protocol to carry out tasks such as reading and writing MAC addresses is also provided.

Although the above embodiment is described with second memory location remaining empty unless a new MAC address is written thereto, and, if there is a failure of writing to the second memory location, the component MAC address is read by default from the first memory location, i.e. the original MAC address provided by the manufacturer, it will be appreciated that the component could be configured in such a way that the original MAC address is initially copied into the second memory location as the “advertised” MAC address until and unless overwritten by a new MAC address.

1. An apparatus for assigning addresses to components in a system, the apparatus comprising:
a central system controller including at least a memory; and
a system communications bus coupled to the central system controller and having a plurality of locations for receiving replaceable components into electrical communication therewith, each of the plurality of locations having a predetermined address associated therewith, information relating to the predetermined addresses being stored in the memory of the central system controller; wherein
the central system controller further comprises a processing module for interrogating, via the system communications bus, a component when it is initially electrically connected to one of the locations of the system communications bus for determining whether there is a component address stored in a memory location of the component that matches the predetermined address associated with that location, and, if not, for issuing instructions to the component to store the predetermined address in a memory location therein and to use the stored predetermined address as its component address, at least while the component is electrically connected to that location of the system communications bus.

2. An apparatus according to claim 1, wherein the central system controller stores in its memory an indication of whether there is a component address stored in a memory location of the component that matches the predetermined address.

3. An apparatus according to claim 2, wherein, when a component is initially electrically connected to one of the locations of the system communications bus, the central system controller receives a message from the component requesting verification that its component address is correct and the central system controller checks its memory to determine whether there is an indication that there is a component address stored in a memory location of the component that matches the predetermined address and, if so, sends a confirmation message to the component.

4. An apparatus according to claim 1, wherein the processing module of the central system controller uses Intelligent Platform Management Interface (IPMI) protocol to communicate with the component.

5. An apparatus according to claim 1, wherein the component comprises a first memory location in which is stored an original component address, the predetermined address being written into a second memory location such that the original component address is maintained in the first memory location.

6. An apparatus according to claim 1, wherein the predetermined address is calculated from a set of rules.

7. An apparatus according to claim 6, wherein the set of rules includes an algorithm for generating the predetermined address from a component address of a component in the system that is not replaceable.

8. An apparatus according to claim 1, wherein the component address is a Media Access Control (MAC) address.

9. A system for assigning addresses to components in the system, the system comprising:
a central system controller including at least a memory;
a system communications bus coupled to the central system controller and having a plurality of locations for receiving replaceable components into electrical communication therewith, each of the plurality of locations having a predetermined address associated therewith, information relating to the predetermined addresses being stored in the memory of the central system controller; and
at least one component electrically coupled respectively at one of the plurality of locations to the system communications bus, the component including at least a first memory location having an original component address stored therein and a second memory location for storing a current component address; wherein
the central system controller further comprises a processing module for interrogating, via the system communications bus, the component when it is initially electrically connected to the system communications bus for determining whether there is a component address stored in a the second memory location of the component that matches the predetermined address associated with that location, and, if not, for issuing instructions to the component to store the predetermined address in the second memory location therein and to use the stored predetermined address as its current component address, at least while the component is electrically connected to that location of the system communications bus.

10. A system according to claim 9, wherein the central system controller stores in its memory an indication of whether there is a component address stored in the second memory location of the component that matches the predetermined address.

11. A system according to claim 10, wherein, when the component is initially electrically connected to one of the locations of the system communications bus, the component sends a message to the central system controller requesting verification that its component address is correct and the central system controller checks its memory to determine whether there is an indication that there is a component address stored in the second memory location of the component that matches the predetermined address and, if so, sends a confirmation message to the component.

12. A system according to claim 9, wherein the processing module of the central system controller uses Intelligent Platform Management Interface (IPMI) protocol to communicate with the component.

13. A system according to claim 9, wherein the predetermined address is calculated from a set of rules.

14. A system according to claim 13, wherein the set of rules includes an algorithm for generating the predetermined address from a component address of a component in the system that is not replaceable.

15. A system according to claim 9, wherein the component address is a Media Access Control (MAC) address.

16. A system according to claim 9, wherein the component uses its original component address as its component address if there is no valid component address stored In Its second memory location.

17. A method of assigning addresses to components in a system, the method comprising the steps of:
detecting a component newly inserted at a location in the system,
reading a component address stored in the component, comparing the component address with a predetermined address associated with the location at which the component has been inserted, and if the component address and the predetermined address do not match, then instructing the component to store the predetermined address and to use it as its component address, at least while it is electrically connected to that location of the system.

18. A method according to claim 17, further comprising a step of calculating the predetermined address according to a set of rules.

19. A method according to claim 18, wherein the set of rules includes an algorithm for generating the predetermined address from a component address of a component in the system that is not replaceable.

20. A method according to claim 17, further comprising a step of storing in the memory of the central system controller an indication of whether there is a component address stored in the component that matches the predetermined address.

21. A method according to claim 20, further comprising a step of sending a message from the component to the central system controller after the component is initially electrically connected to one of the locations of the system communications bus requesting verification that its component address is correct; and the central system controller checking its memory for the indication whether there is a component address stored in the component that matches the predetermined address and, if so, sending a confirmation message to the component.

22. A method according to claim 17, further comprising a step of storing an original component address in a first memory location of the component, and writing the predetermined address into a second memory location such that the original component address is maintained in the first memory location.

23. A method according to claim 22, wherein the component uses its original component address as its component address if there is no valid component address stored in its second memory location.

24. A method according to claim 17, wherein Intelligent Platform Management Interface (IPMI) protocol is used for communication with the component.

25. A method according to claim 17, wherein the component address is a Media Access Control (MAC) address.
